(19) United States
(12) Patent Application Publication
(10) Pub. No.: US 2016/0041022 A1
(43) Pub. Date: Feb. 11, 2016

(54) FLUID LEVEL AND VOLUME MEASURING SYSTEMS AND METHODS OF MAKING AND USING THE SAME

(71) Applicant: Jeffrey Brian CAPLAN, Newport News (VA)

(72) Inventors: Jeffrey Brian Caplan, Newport News, VA (US); Bryant Douglas Taylor, Smithfield, VA (US)

(21) Appl. No.: 14/407,463

(22) PCT Filed: Jun. 11, 2013
(86) PCT No.: PCT/US13/45235

§ 371 Date: Dec. 11, 2014

Related U.S. Application Data
(60) Provisional application No. 61/658,673, filed on Jun. 12, 2012.

(51) Int. Cl. G01F 23/284

(52) U.S. Cl. CPC G01F 23/284

(57) ABSTRACT

Magnetic field response sensors for use in measuring the volume of a fluid, the type of fluid and/or any contaminants within a fluid container or tank. Fluid containers having sensors systems including two or more sensors for use in measuring fluids and methods of using the same.

### RELATED APPLICATION

This application claims priority to U.S. Provisional Application No. 61/658,673, filed Jun. 12, 2012, hereby incorporated by reference.

### FIELD OF THE INVENTION

The invention relates to the use of wireless open-circuit magnetic field response sensors in fluid containers, preferably fuel tanks, or other containers for measuring volumes and/or fluid levels and methods of making and using the same.

### BACKGROUND OF THE INVENTION

Several publications are referenced in this application. The cited references describe the state of the art to which this invention pertains and are hereby incorporated by reference, particularly the systems, devices, products, and methods set forth in the detailed description and figures of each reference.

A variety of fuel level or volume measuring systems have been used in the past. Ranging from level markers on the wall of a container for estimating measurements to the use of floating devices. Most automobiles use a rheostat connected to a float called a sender unit to measure the fuel level in the gas tank. U.S. Pat. No. 4,827,769 to Riley et al., hereby incorporated by reference, describes a level sensor where a movable float disposed about an insulated vertical member rises and falls with the liquid level. U.S. Pat. No. 6,915,691 to Koike, hereby incorporated by reference, relates to a fuel tank level sensor for measuring a remaining amount of fuel in accordance with a resistance value which is varied by moving a rheostat utilizing a float. U.S. Pat. No. 7,093,485 to Newman et al., hereby incorporated by reference, discloses a fuel level sensor that incorporates a float and pivot arm member attached to a hub that rotates about a pivot base. These references describe prior “float” measurement technologies that have been used in automobiles for over seventy years.

### SUMMARY OF THE INVENTION

The invention relates to magnetic field response sensors for use in measuring the volume of a fluid, the type of fluid and/or any contaminants within a fluid container or tank.

One embodiment of the invention relates to fluid containers having at least a first and second magnetic field response sensor embedded within the walls of a container or tank to measure the fluid.

Another embodiment relates to fluid containers having at least a first and second magnetic field response sensor secured to an outside wall of a container to measure the fluid.

Another embodiment relates to fluid containers having at least a first and second magnetic field response sensor secured to an inside wall of a container to measure the fluid

Yet another aspect of the invention relates to synergies created when two or more sensors are capable of working together when obtaining one or more measurements.

Yet another aspect of the invention relates to tubes or probes comprising one or more sensors according to the invention.

A still further aspect of the invention relates to automobiles, trucks, boats and aircraft comprising the fuel containers according to the invention.

The foregoing has outlined some of the aspects of the present invention. These objects should be construed as being merely illustrative of some of the more prominent features and applications of the invention. Many other beneficial results can be obtained by modifying the embodiments within the scope of the invention. Accordingly other objects and a full understanding of the invention may be had by referring to this summary of the invention, the detailed description describing the preferred embodiment in addition to the scope of the invention defined by the claims taken in conjunction with the accompanying drawings. The unique features characteristic of this invention and operation will be understood more easily with the description and drawings. It is to be understood that the drawings are for illustration and description but does not define the limits of the invention.

### BRIEF DESCRIPTION OF THE DRAWINGS

The abovementioned and other features of the inventions disclosed herein are described below with reference to the drawings of the preferred embodiments. The illustrated embodiments are intended to illustrate, but not to limit the inventions. The drawings contain the following figures:

FIG. 1 is a schematic drawing of open-circuit magnetic field response sensors including a first sensor and a second sensor according to one embodiment of the invention.

FIG. 2 is a schematic drawing of an open-circuit magnetic field response sensor system according to another embodiment of the invention.

FIG. 3 is a schematic drawing of open-circuit magnetic field response sensors including a first sensor and a second sensor according to another embodiment of the invention.

FIG. 4 is a schematic drawing of an open-circuit magnetic field response sensor system according to another embodiment of the invention.

FIG. 5 is a schematic drawing of a tube sensor system including a first sensor and a second sensor according to another embodiment of the invention.

FIG. 6 is a schematic drawing of a tube sensor system including a first sensor and a second sensor according to another embodiment of the invention.

FIG. 7 is a schematic drawing of a sensor system having sensors located at different container locations.

FIG. 8 is a schematic drawing of a tube sensor system having multiple sensors along the tube length.

FIG. 9 is a schematic drawing of a sensor according to another embodiment of the invention.

FIGS. 10A-B are schematic drawings of an open-circuit magnetic field response sensor according to another embodiment of the invention.

FIG. 11 is a schematic drawing of the sensor of FIGS. 10A-B bonded to the outside wall of a polyethylene fuel tank.

### DETAILED DESCRIPTION OF THE INVENTION

The abovementioned and other features of the inventions disclosed herein are described below with reference to the drawings of the preferred embodiments. While the present description sets forth specific details of various embodiments, it will be noted that the description is illustrative only and should not be construed in any way as limiting. This description may set forth examples of embodiments incorporating certain structural, design or functional components, the present inventions contemplate the use of any type of present or future structural, design or functional components with the sensor systems.

One aspect of the invention relates to a fluid container having a fluid sensor system comprising one or more sensors, preferably, open-circuit magnetic field response sensors.

Preferred embodiments relate to the use of at least one wireless magnetic field response sensor embedded into the wall of a polyethylene fuel tank or any non-conductive container. The invention provides a more reliable means of measuring the amount of fuel in a tank, preferably achieved by embedding the fuel level sensor into the wall of the fuel tank. The preferred fuel level sensor used according to the invention is an open circuit thin film spiral trace circuit so arranged as to resonate when excited by a time varying magnetic field.

Preferably, the resonate frequency of the sensor will change when fuel moves into the magnetic field of the sensor. The change in frequency can also be correlated into a change in fuel level by an electronic interrogator that excites the embedded sensor via an electromagnetic antenna in close proximity to the sensor. The same antenna is used to read the response from the sensor.

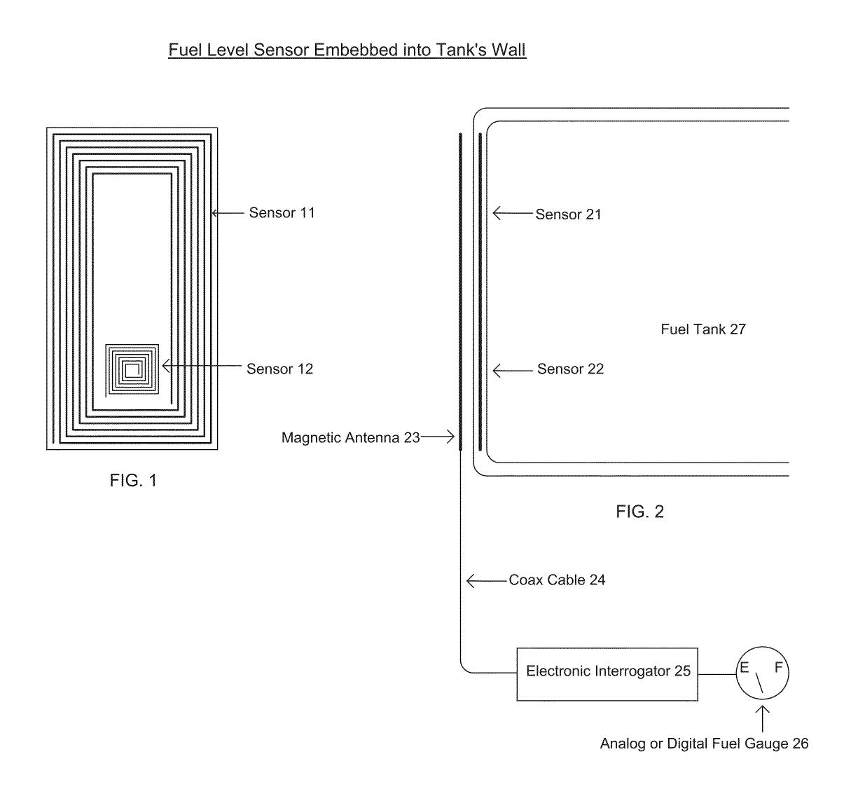

FIG. 1 shows a drawing of an open-circuit magnetic field response sensor 11 with the addition of another open-circuit magnetic field response sensor 12. Sensor 11 measures the fuel level and sensor 12 measures the dielectric constant of the fuel in the tank (not shown in FIG. 1). The type of fuel in the tank is determined by measuring the dielectric constant of the liquid. By knowing the type of fuel in the tank, the proper correction values for sensor 11 can be applied in an electronic interrogator 25 (e.g., shown in FIG. 2) so accurate fuel level measurements can be made with different types of fuel.

FIG. 2 shows a drawing of a sensor system including an open-circuit magnetic field response sensor 21 and an open-circuit magnetic field response sensor 22 (for example the sensors of FIG. 1) embedded into the wall of a plastic fuel tank 27, along with magnetic antenna 23 positioned outside the tank 27. The sensor is preferably embedded into the tank's wall at the time the tank is manufactured. This is preferably accomplished by positioning the sensor into the mold prior to injecting the plastic. The magnetic antenna 23 excites sensor 21 and sensor 22 via a time-varying magnetic field. Sensor 21 and sensor 22 respond with their own time-varying magnetic field. Magnetic antenna 23 receives this time-varying magnetic field and conveys the signals to the electronic interrogator 25 via a coax cable 24. Electronic interrogator 25 converts the signals from sensor 21 and sensor 22 to a voltage that can drive an analog or digital fuel gauge or any data acquisition system.

Preferably, the sensors comprise a square or rectangle spiral trace made of copper or any conductive material as shown in FIG. 1 or 2. Preferably, sensor 11 is larger than sensor 12. Even more preferably, sensor 12 is a square spiral trace within the larger square or rectangle spiral trace of sensor 11.

The invention provides advantages compared to prior systems. For example, prior systems using a rheostat connected to a float wears out with the constant motion of the float pulling the wiper of the rheostat back and forth across a resistive bar. When the sender unit wears out, the fuel tank has to be removed in order to replace it. Applicants believe the reason automobile manufacturers have not replaced these sender units is because there is no improved fuel level measuring technology that would meet the cost and reliability the automobile industry is looking for. The current invention satisfies both of these requirements. The open-circuit magnetic field response sensors of the invention can be very inexpensive to manufacture and may be embedded into the fluid container (e.g., fuel tank) at the manufacturing facility. Once embedded into the container or tank, the sensor would be practically indestructible since there are no moving parts and it is protected from outside sources and/or the fluids contained in the tank or container. Installation of the tank into the automobile would be easier because there are no direct electrical connections to the sensor.

One embodiment of the invention provides a non-mechanical open-circuit magnetic field response wireless sensor and sensing system or sensor system that can be used to measure fluid within a container, preferably measure the fuel and/or fuel level in the fuel tanks of automobiles, boats, ships, aircraft and other vehicles or systems that have fuel tanks. The invention could also be used in other fluid tanks such as water tanks, waste tanks, etc. For example, the sensor system could be used to detect the level of a water tank or when a waste tank needs to be replaced or emptied.

Preferably, the wireless sensor and sensing system can measure the type of fuel and/or the level of fuel in the tank. Preferably the wireless sensor and sensing system can measure both the type of fuel and the level of fuel in the tank.

Preferably, the wireless sensor and sensing system can also measure contaminants in the fuel. According to one preferred embodiment, the system can measure the level of the fuel and contaminants in the fuel. According to another preferred embodiment, the system can measure the type of fuel and the contaminants in the fuel. According to yet another preferred embodiment, the system can measure the type of fuel, the fuel level and contaminants in the fuel. According to particularly preferred embodiment, the sensor system can measure the amount of contaminants and/or type of contaminants.

According to preferred embodiments, the small sensor within the field of the larger sensor can detect the type of fuel but also the quality of the fuel. For example, if water or other contaminates were in the fuel this sensor would detect an abrupt change that is outside the normal readings for the type of fuel to be used. This reading could be used to indicate a problem with the fuel and prevent the engine from being started.

According to another particularly preferred embodiment, the sensor system provides an indication (e.g., an audible alarm, visual alarm (e.g., light) or other indication or combinations therefore) if the system detects and/or senses the wrong type of fuel and/or contaminants. Preferably, the system also disables an ignition system (e.g., of an engine) if the system senses the wrong type of fuel and/or contaminants.

Another embodiment of the invention includes two or more wireless sensors and a sensing system that can be used to measure the volume of any type of liquid in both conductive and non-conductive containers.

Another embodiment of the invention includes a wireless sensor and sensing system that can be used to measure the fluid level in a non-conductive container where the sensor is embedded into the wall of a non-conductive container (e.g., a fuel tank).

Another embodiment of the invention relates to a fluid container system having a sensor system comprising: (a) a first magnetic field response sensor embedded within a wall of the fluid container; and (b) a second magnetic field response sensor embedded within the wall of the fluid container; wherein the first magnetic field response sensor and the second magnetic field response sensor are each capable of measuring at least one of the following: (i) fluid level within the fluid container; (ii) fluid type within the fluid container; and (iii) contaminants within the fluid container. Preferably, at least two of (i)-(iii) and most preferred each of (i)-(iii).

Another embodiment of the invention provides a wireless sensor and sensing system that can be used to measure the level of any type of liquid in both conductive and non-conductive containers. According to preferred embodiments of the invention, the system is “wireless”. That is, even though wires are used in the sensing system, the term wireless is used in the description of this invention because the sensor itself is preferably a thin film open-circuit electrical conductor so shaped such that it can store electrical and magnetic energy. In the presence of a time-varying magnetic field, the conductor resonates to generate a response having frequency, amplitude and bandwidth. This response contains information about the liquid in proximity to the sensor's magnetic field. Excitation is applied to the sensor via a time-varying magnetic field from an antenna in close proximity to the sensor. Hence, there is no direct electrical contact to the sensors needed.

Preferably, the system comprises no direct electrical contact to the first magnetic field response sensor and no direct electrical contact to the second magnetic field response sensor.

Preferably, the first magnetic field response sensor and the second magnetic field response sensor are each non-mechanical open-circuit magnetic field response wireless sensors.

Preferably, the sensor system is non-mechanical and/or comprises no moving parts.

Preferably, the first magnetic field response sensor and the second magnetic field response sensor do not include a float and/or the sensor system does not include a float.

According to preferred embodiments, the first magnetic field response sensor and the second magnetic field response sensor are each thin film open-circuit magnetic field response wireless sensors. Suitable related thin film sensors, and methods of making the same, are described in U.S. Pat. No. 7,086,593 to Woodard et al., hereby incorporated by reference.

Preferably, the second magnetic field response sensor is smaller than the first magnetic field response sensor. More preferably, the second magnetic field response sensor is positioned within the field of the first magnetic field response sensor.

According to preferred embodiments, the first magnetic field response sensor and the second magnetic field response sensor are each a thin film open-circuit electrical conductor shaped to store electrical and magnetic energy.

Sensors systems according to the invention preferably further comprise a magnetic antenna designed, adapted and/or configured for the corresponding sensor. According to preferred embodiments, the systems further comprise at least one antenna in proximity to the first magnetic field response sensor and the second magnetic field response sensor and is capable of applying excitation to the sensors. Preferably, the excitation is applied via a time-varying magnetic field from the magnetic antenna.

Preferably, the systems comprise an external magnetic antenna proximate the first magnetic field response sensor and the second magnetic field response sensor (preferably within 50 cm, more preferably within 25 cm, even more preferably within 10 cm, even more preferably within 5 cm and most preferred within 1 cm). According to preferred embodiments, the distance between the antenna and sensor(s) is within 1 to 5 centimeters. According to alternative preferred embodiments, increased transmitting power and a higher receiver gain are used and distances up to 50 centimeters can be achieved.

Preferably, the magnetic antenna is capable of exciting the first magnetic field response sensor and the second magnetic field response sensor using a time-varying magnetic field and is also capable of receiving time-varying magnetic field signals from the first magnetic field response sensor and the second magnetic field response sensor and conveying those signals to an electronic interrogator. According to preferred embodiment, the system includes a magnetic antenna that is capable, designed, configured and/or adapted for applying excitation to at least two or more sensors, preferably at least three or more, even more preferably at least five or more.

According to further embodiments, the sensor system further comprises an electronic interrogator. Preferably, the electronic interrogator is capable of converting the signals from sensors to at least one voltage that can drive an analog or digital fluid gauge or other data acquisition system or indicator.

Preferably, the system comprises a magnetic antenna embedded within the wall of the container. Preferably, the sensors and antenna are embedded in the same plane within the container wall.

According to another embodiment, the systems comprise a coax cable connected to the magnetic antenna and protruding through a container wall for connection to an electrical interrogator.

According to preferred embodiments, the first magnetic field response sensor and the second magnetic field response sensor are embedded in the wall by positioning the sensors within a mold prior to injecting plastic to form the container. According to alternative embodiments, the sensors are secured to the inner or outer wall or otherwise deposited or formed on the container wall to form the sensor.

Preferred embodiments of the invention relate to fuel tanks or fuel containers comprising the sensor systems of the invention. Accordingly, preferably, the fluid is a fuel, more preferably, oil, gasoline or other petroleum based fluid.

Preferably, the container is an automobile fuel container. Accordingly, another aspect of the invention relates to automobiles, trucks, boats and aircraft comprising the fuel containers according to the invention.

Preferably, the container is a plastic container, preferably a polyethylene fuel container.

Another aspect of the invention relates to synergies created when two or more sensors are capable of working together when obtaining one or more measurements.

According to one embodiment, the first magnetic field response sensor and said second magnetic field response sensor each resonate to generate a response having frequency, amplitude and bandwidth. According to preferred embodiments, the first magnetic field response sensor is capable of measuring the fluid level and the second magnetic field response sensor is capable of detecting the fluid type. Preferably, the second magnetic field response sensor is capable of detecting fluid type by measuring the dielectric constant of the fluid. According the further preferred embodiments, the first magnetic field response sensor can be calibrated by the measurement of the second magnetic field response sensor to increase the accuracy of the fluid level measurement.

Preferably, the system further comprises an electronic interrogator programmed with software that interrogates both sensors and combines the information to read or determine the level of any liquid. Preferably, the system further comprises an electronic interrogator capable of reading each sensor and combining results to measure the fluid.

Another aspect of the invention relates to fluid sensor systems having one or more sensors secured to an outside wall of the fluid container.

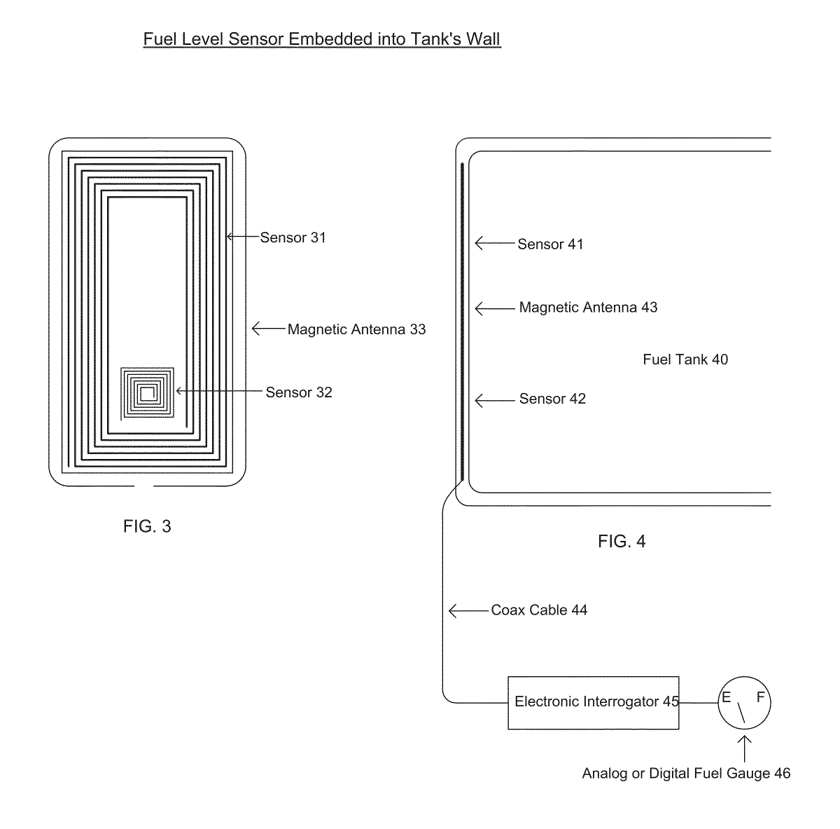

FIG. 3 shows an open-circuit magnetic field response sensor 31, and an open-circuit magnetic field response sensor 32 and a magnetic antenna 33, preferably together on the same plane.

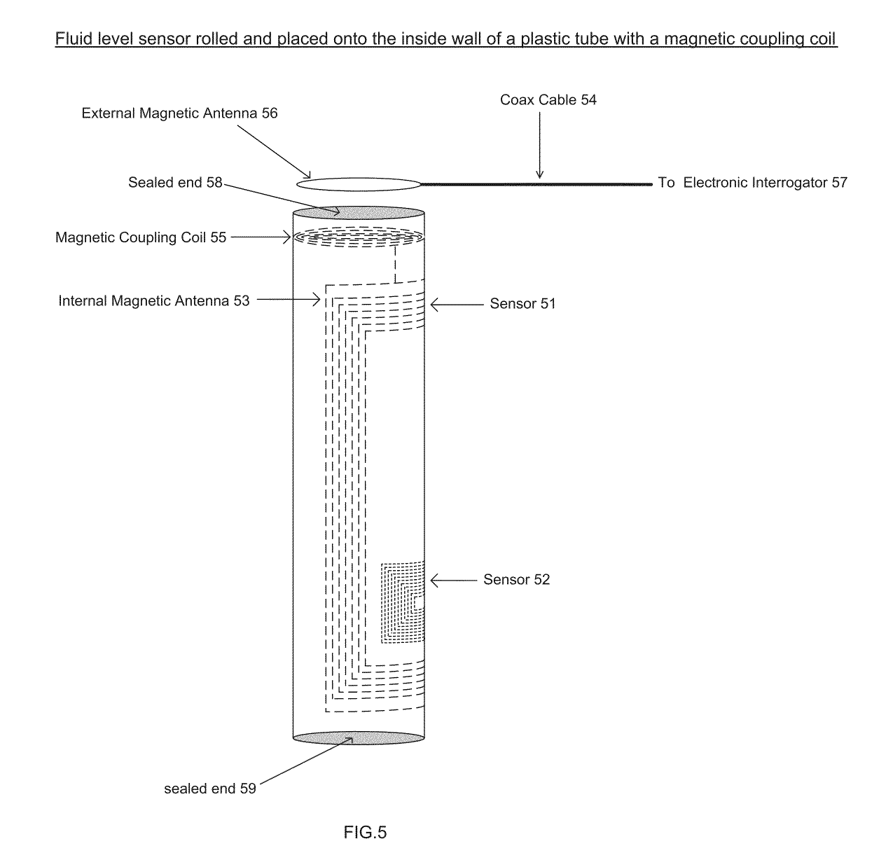

FIG. 4 shows a drawing of an open-circuit magnetic field response sensor 41, and an open-circuit magnetic field response sensor 42, and magnetic antenna 43 (for example, the sensors and antenna shown in FIG. 3) embedded into the wall of a plastic tank with the coax cable 44 protruding through the wall of the tank. This arrangement allows for the fuel level sensor, antenna, and coax cable to be part of the tank, whereas the first arrangement FIG. 2 allows for the antenna to be separate from the tank. Either arrangement accommodates and allows for the production and cost issues in incorporating this system for practical applications.

One embodiment of the invention relates to a fluid sensor system for a fluid container comprising:
(a) a first magnetic field response sensor secured to an outside wall of the fluid container; and
(b) a second magnetic field response sensor secured to the outside wall of the fluid container;

wherein the first magnetic field response sensor and the second magnetic field response sensor each measure at least one of the following: (i) fluid level within the fluid container; (ii) fluid type within the fluid container; and (iii) contaminants within the fluid container.

According to preferred embodiments, the container is a non-conductive container.

Preferably, the sensor system does not employ a float to measure the fluid.

According to preferred embodiments, the system further comprises a magnetic antenna, preferably an external magnetic antenna proximate the first magnetic field response sensor and the second magnetic field response sensor.

Preferably, the system further comprises a magnetic antenna embedded within the wall of the fluid container and/or a magnetic antenna secured to the outside wall of the fluid container.

Preferably, the sensors and antenna are secured on the same plane of the fluid container wall.

Another embodiment of the invention relates to a method of measuring fluid within a fluid container, the method comprising:

(a) exciting at least a first magnetic field response sensor and a second magnetic field response sensor with a magnetic antenna, preferably using a time-varying magnetic field;

(b) receiving signals (preferably time-varying magnetic field signals) from the first magnetic field response sensor and the second magnetic field response sensor; and

(c) conveying those signals to an electronic interrogator.

Preferably, the first magnetic field response sensor and the second magnetic field response sensor measure at least one of the following: (i) fluid level within the fluid container; (ii) fluid type within the fluid container; and (iii) contaminants within the fluid container.

Preferably, the first magnetic field response sensor measures the fluid level and the second magnetic field response sensor detects the fluid type.

Preferably, the first magnetic field response sensor and the second magnetic field response sensor each resonate to generate a response having a frequency, amplitude and bandwidth.

According to preferred embodiments, the first magnetic field response sensor measures the fluid level and the second magnetic field response sensor detects the fluid type. Preferably, the second magnetic field response sensor detects the fluid type by measuring the dielectric constant of the fluid.

Preferably, the first magnetic field response sensor is calibrated by the measurement of the second magnetic field response sensor to increase the accuracy of the fluid level measurement or other measurement.

Preferably, the system further comprises an electronic interrogator that converts the signals from sensors to at least one voltage that can drive an analog or digital fluid gauge or other data acquisition system or indicator. Accordingly, preferred methods further comprise the step of converting the signals to at least one voltage that can drive gauges or other systems.

Another aspect of the invention relates to tubes or probes comprising one or more sensors according to the invention.

FIG. 5 shows a drawing of open-circuit magnetic field response sensors 51 and 52 applied to the inside wall of a plastic tube or any non-conductive hollow tube. A spiral trace magnetic coupling coil 55 is connected to internal magnetic antenna 53. External magnetic antenna 56 connects to electronic interrogator 57 via coax cable 54. This embodiment of the invention allows the sensor to be used in metal or conductive containers since an open-circuit magnetic field response sensor will not function if covered in metal. The plastic tube is inserted as a probe into a metal container to measure the fuel level or any liquid level in the container. Both ends of the tube are preferably sealed if the tube is not solid or is hollow or partly hollow.

Another aspect of the application relates to at least a first magnetic sensor and a second magnetic sensor used to measure fluid within a metal or conductive container or tank.

Another aspect of the invention relates to systems having two or more fluid level sensor(s) placed on the inside wall of a non-conductive (e.g., plastic) tube.

One embodiment of the invention relates to a fluid sensor probe comprising:
(a) a first magnetic field response sensor and a second magnetic field sensor, each sensor secured on an inner surface of a non-conductive tube, preferably hollow tube;
(b) an internal magnetic antenna also secured on the inner surface of the tube; and
(c) a magnetic coupling coil connected to the internal magnetic antenna.
wherein:
   preferably, both ends of the hollow tube are sealed; and

the system comprises no direct electrical contact to the first magnetic field response sensor and no direct electrical contact to the second magnetic field response sensor.

Preferably, the non-conductive hollow tube is filled with a non-conductive material, preferably a silicon rubber compound.

Preferably, the first magnetic field response sensor and the second magnetic field response sensor each measure at least one of the following: (i) fluid level within the fluid container; (ii) fluid type within the fluid container; and (iii) contaminants within the fluid container.

Preferably, the system further comprises an external magnetic antenna proximate one end of the hollow tube. Preferably, the system further comprises a cable capable of connecting the external magnetic antenna to an electronic interrogator.

Another embodiment of the invention relates to a fluid sensor probe comprising:
(a) a first magnetic field response sensor and a second magnetic field sensor, each sensor embedded within a wall of a non-conductive tube, preferably hollow tube;
(b) an internal magnetic antenna also embedded with the wall of the hollow tube; and
(c) a magnetic coupling coil connected to the internal magnetic antenna.
   wherein:
   preferably, both ends of the tube are sealed; and
   the system comprises no direct electrical contact to the first magnetic field response sensor and no direct electrical contact to the second magnetic field response sensor.

Preferably, the first magnetic field response sensor and the second magnetic field response sensor each measure at least one of the following: (i) fluid level within the fluid container; (ii) fluid type within the fluid container; and (iii) contaminants within the fluid container.

Preferably, the non-conductive hollow tube is filled with a non-conductive material, preferably a silicon rubber compound.

Another embodiment relates to a fluid sensor probe comprising:
(a) a first magnetic field response sensor and a second magnetic field sensor, each secured on an inner surface of a non-conductive tube, preferably hollow tube;
(b) an internal magnetic antenna within the hollow tube;
(c) a magnetic coupling coil connected to the internal magnetic antenna;
(d) an external magnetic antenna proximate one end of the hollow tube; and
(e) a cable capable of connecting the external magnetic antenna to an electronic interrogator;
wherein:
preferably, both ends of the hollow tube are sealed;
the system comprises no direct electrical contact to the first magnetic field response sensor or the second magnetic field response sensor; and
the first magnetic field response sensor and the second magnetic field response sensor each measure at least one of the following: (i) fluid level within the fluid container; (ii) fluid type within the fluid container; (iii) contaminants within the fluid container.

Preferably, the non-conductive hollow tube is filled with a non-conductive material, preferably a silicon rubber compound.

Another embodiment of the invention relates to systems having both the sensors and the antenna on the inner surface, outer surface and/or embedded within the tube wall. According to preferred embodiments, the sensor(s) can also be rolled and inserted into a plastic tube. This would allow the sensor to be used in metal tanks. The rolled sensor inside a plastic tube can be used to measure the level in waste water tanks providing advantages since paper and other debris would not get stuck on the smooth plastic tube. This would solve the problem with current waste water tank level sensors that use a float inside a tube with holes. Moreover, multiple plastic tube sensors could used to measure the volume of liquid at different attitudes.

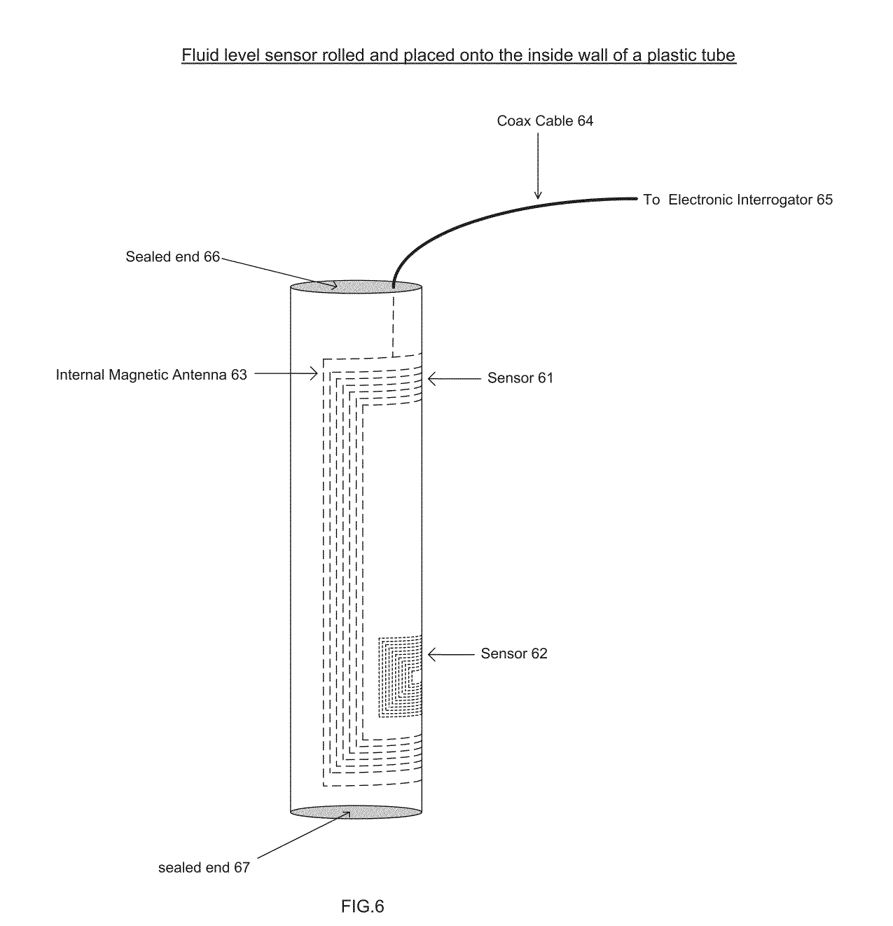

FIG. 6 shows a drawing of open-circuit magnetic field response sensors 61 and 62 along with magnetic antenna 63 applied to the inside wall of a plastic tube or any non-conductive hollow tube. Magnetic antenna 63 is connected to coax cable 64 that protrudes from one end of the tube. Coax cable 64 connects magnetic antenna 63 to electronic interrogator 65. Both ends of the tube are preferably sealed. This embodiment of the invention allows the sensor to be used in metal or conductive containers since an open-circuit magnetic field response sensor will not function if covered in metal. The plastic tube is inserted as a probe into a metal container to measure the fuel level or any liquid level in the container.

One embodiment of the invention relates to a fluid sensor probe comprising:
(a) a first magnetic field response sensor and a second magnetic field sensor, each secured on an inner surface of a tube, preferably a non-conductive hollow tube;
(b) an internal magnetic antenna within the hollow tube; and
(c) a cable capable of connecting the internal magnetic antenna to an electronic interrogator by protruding from one end or from a wall of the hollow tube;

wherein:

preferably, if a hollow tube, both ends of the hollow tube are sealed;

the system comprises no direct electrical contact to the first magnetic field response sensor or the second magnetic field response sensor; and

preferably the first magnetic field response sensor and the second magnetic field response sensor each measure at least one of the following: (i) fluid level within the fluid container; (ii) fluid type within the fluid container; and/or (iii) contaminants within the fluid container.

Preferably, the non-conductive hollow tube is filled with a non-conductive material, preferably a silicon rubber compound.

Preferably, the container or tank is non-conductive. According to specific embodiments, the sensors are embedded in a non-conductive or protective film or layer or otherwise coated or protected with a non-conductive layer to be used within tanks with corrosive fluids and/or with conductive containers. Preferably, the protected sensor(s) are then secured to the container wall or otherwise positioned for measurement.

Another aspect of the invention relates to fluid containers or tanks comprising two or more sensor systems according to the invention. According to preferred embodiments, the small sensor is not limited to just one sensor; there could be multiple small sensors depending on the application and/or multiple larger sensors. Two of more fuel level sensors could be embedded or attached to a plastic tank at different locations and work together to measure the volume of fuel providing accurate fuel measurements at different attitudes. For example, a car or truck going up and down hills, or a speed boat bouncing around on the water or an airplane at different pitch and rolls attitudes. Using two or more open-circuit wireless magnetic field response sensors at different locations working together to achieve a certain measurement, the fluid level or volume of any liquid in any container can be determined regardless of the container's or tank's attitude. Preferably, an electronic interrogator unit is programmed with software that interrogates both sensors and combines the information to read the level of any liquid.

Another embodiment relates to a fluid volume measuring system having multiple sensors positioned at different points around a container providing a liquid volume measurement system produced by combining the readings into an electronic interrogation unit using software to produce a reading of the volume of any liquid in a container at different attitudes.

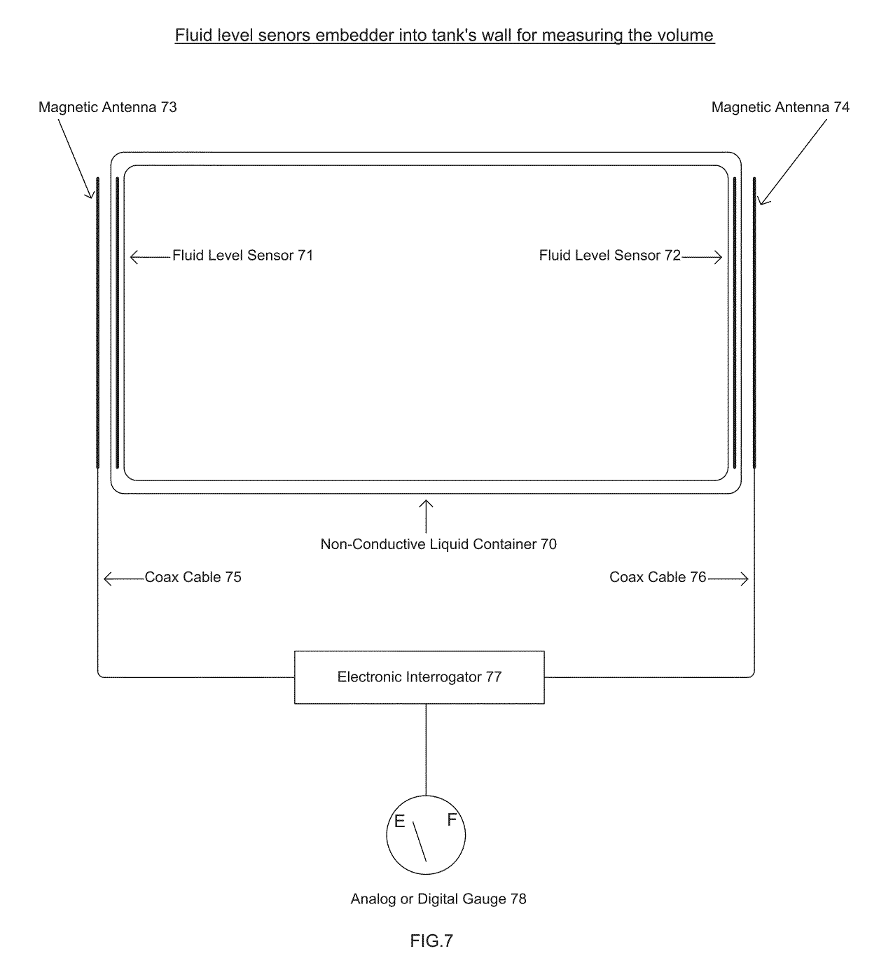

FIG. 7 shows a drawing of two fluid level sensors 71 and 72 embedded into the wall of a plastic container 70. Each fluid level sensor is preferably composed of two open-circuit magnetic field response sensors such as those shown in FIG. 1. The system includes magnetic antenna 73 to activate sensor 71 and magnetic antenna 74 to activate 72, and preferably coax cables 75 and 76 leading to electronic interrogator 77, which is preferably connected to analog or digital gauge 78. By having a sensor at each end of the tank 70, the fluid level is measured at different pitch angles. The reading obtained from each sensor is combined in electronic interrogator 77 to produce a volume reading of the liquid in the tank at different pitch angles. If a sensor is embedded into each of the four walls of the container, all four readings could be combined into the electronic interrogator 77 to read the volume of the liquid in the tank at different pitch and roll angles. This would be useful in measuring the fuel quantity in airplane or boat fuel tanks where the vehicle is subject pitch, yaw and roll attitudes (i.e., pitch, nose up or down about an axis running from wing to wing; yaw, nose left or right about an axis running up and down; and roll, rotation about an axis running from nose to tail). The axes are alternatively designated as lateral, vertical, and longitudinal and can be used to describe the various positions typical fuel tanks can take in a variety of vehicles (e.g., trucks, boats, airplanes, etc.). As the fuel tank shifts its position (whether a pitch, yaw or roll attitude), the fluid within the tank shifts. Deploying multiple sensor systems at different locations allows the fluid level to continue to be measured. The same principle could be applied in a metal tank using multiple sensors inside the plastic tubes as shown in FIG. 5 and FIG. 6.

One embodiment of the invention relates to a fluid container comprising at least two sensor systems or sensors described above, each sensor system located at different container positions or locations.

Preferably, each sensor system is located at different container positions and the measuring system capable of combining measurements from the at least two sensor systems to generate a measurement of fluid within the fluid container at different attitudes, different pitch/roll/yaw angles, accelerations and/or combinations thereof.

According to preferred embodiment, the container comprises a first sensor system positioned on a first wall of the fluid container and a second sensor system positioned on a second wall of the fluid container. Preferably, the container further comprises a third sensor system positioned on a third wall of the fluid container. Even more preferred, the container further comprises a fourth sensor system positioned on a fourth wall of the fluid container.

According to preferred embodiments, a measurement reading obtained from each sensor is combined in an electronic interrogator to produce a volume reading of the fluid in the container tank at different pitch or roll angles and/or different altitudes. For example, four sensor systems placed on the sidewalls of an aircraft fuel tank could work together to measure the amount of fuel in the tank regardless of the pitch of the aircraft.

Another aspect of the invention relates to sensor systems (or fluid containers or tanks comprising two or more sensor systems) according to the invention wherein sensors or sensor systems are placed linearly or along the length or height of a probe or container wall to measure deep containers or tanks.

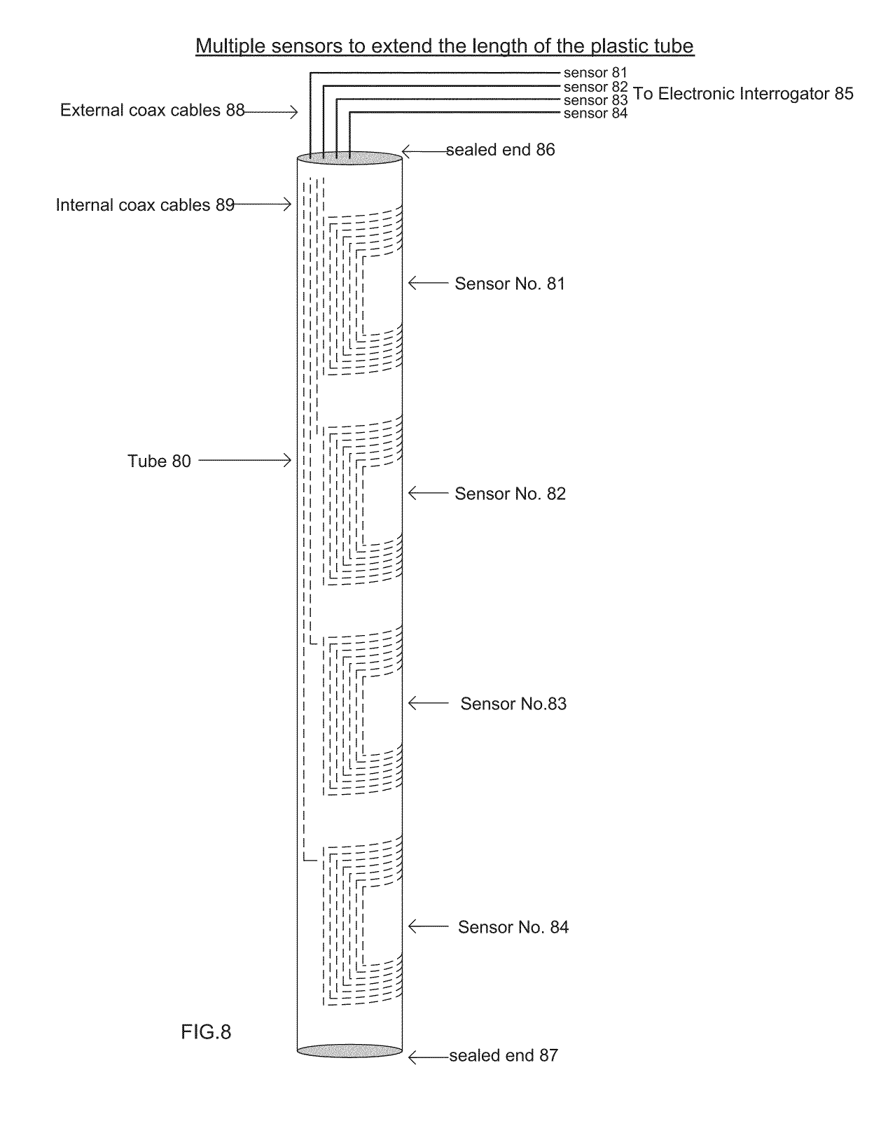

FIG. 8 shows a drawing of four open-circuit magnetic field response sensors 81, 82, 83 and 84 inside a plastic tube 80 with each end (86 and 87) sealed. Four coax cables 88 connect to the internal magnetic antenna (not shown) of each sensor. Each coax cable connects to each sensor's internal magnetic antenna via internal coax cables 89. The four sensors 81, 82, 83, and 84 are interrogated by electronic interrogator 85 via the coax cables 88. The signal from each sensor is processed by software in the electronic interrogator 85 to measure the liquid level outside the full length of the plastic tube 80. The drawing of FIG. 8 is not limited to four sensors, but can have any number of sensors depending on the length of the tube and the depth of the liquid to be measured. According to preferred embodiments, the sensor at the bottom of the tube can be used to measure the type of fluid. The bottom sensor is preferably used to measure the type of liquid because it will likely be completely immersed in the liquid when used within a container. According to another preferred embodiment, the sensors comprise a single sensor without the embedded second sensor within a sensor (e.g., FIG. 3 without sensor 33).

Accordingly, another embodiment of the invention relates to a liquid level measuring system for measuring the liquid level in deep or large containers by using multiple open-circuit magnetic field response sensors placed “end to end” (or overlapping or with small gaps) onto a long tube, preferably a non-conducting tube and preferably using an electronic interrogation circuit controlled by software to interrogate each sensor and produce a liquid level reading for the liquid outside of the full length of the non-conductive tube inserted into the liquid.

Another embodiment of the invention relates to a fluid container having a fluid sensor system comprising at least a first magnetic field response sensor and a second magnetic field sensor aligned linearly within or on a surface, wherein the first magnetic field response sensor and the second magnetic field response sensor are each capable of measuring at least one of the following: (i) fluid level within the fluid container; (ii) fluid type within the fluid container; and (iii) contaminants within the fluid container.

Another embodiment of the invention relates to a fluid sensor probe comprising at least a first magnetic field response sensor and a second magnetic field sensor, each sensor positioned along the length of a non-conductive hollow tube. Preferably, the probe further comprises a third sensor system positioned along the length. Even more preferred, a fourth sensor system.

According to other preferred embodiments, the probe may include 5 or more, 10 or more, sensors depending on the length of the probe and/or depth of the tank and/or the types of measurements required.

Preferably, the probe further comprises a magnetic antenna for each sensor. Preferably, one antenna for two or more sensors. Alternatively, an antenna for each sensor.

Preferably, the probe having multiple sensors further comprise one or more internal embedded coax cables connecting each sensor's internal magnetic antenna to one or more corresponding external coax cables.

Preferably, the non-conductive hollow tube is filled with a non-conductive material, preferably a silicon rubber compound.

Systems currently being used to measure the fluid level in large tanks having dimensions from five feet to over thirty feet include (i) radar, (ii) ultrasound, (iii) pressure, and (iv) a bubbler system. There are a few others, but these are believed to be the most often used in commercial applications. However, all of these systems are complicated, expensive, and have their problems. The radar system sends a microwave signal from a transducer mounted onto the top of the tank. This signal bounces off the fluid and is picked up by the transducer. The fluid level is made by measuring the time it takes for the signal to return. The ultrasound works the same way but instead of a microwave signal, the ultrasound uses a high frequency sound signal. The pressure system uses a pressure transducer mounted in the bottom of the tank. The fluid level is made by measuring the signal from the pressure transducer which is a measurement of the weight of the liquid in the tank. The bubbler uses a long tube inserted into the tank. Air is pumped into the tube and the air pressure is measured. The air pressure correlates to the fluid in the tank. This system is called a bubbler because air bubbles are constantly bubbling from the bottom of the tube. All of these systems require maintenance and calibration checks.

The system according to the invention shown in FIG. 8 can be made in lengths ranging from inches to five feet to over thirty feet with more sensors required for longer tubes. Some of the advantages of present invention including: (a) no moving parts, (b) less complicated electronics, (c) very little maintenance if any, and (d) a sealed probe (the tube) with no active electronic components (e.g., transistors, integrated circuits and other components that consume power) inside to fail. The sensor probe according to preferred embodiments preferably uses open circuit magnetic field response sensors that preferably are formed using copper traces on a Kapton film, a technique known in the industry as flexible printed circuit boards.

The probe according to the invention is preferably self-calibrating to the type of liquid it is inserted in, preferably, by using the sensor at the very bottom to measure the dielectric constant of the surrounding liquid. This same sensor preferably also measures the fluid level near the bottom of the tank.

According to another preferred embodiment of the invention relates to a sensor probe having a sensor at a bottom end capable detecting the type of liquid and/or measuring the dielectric constant of the surrounding liquid. Preferably, the bottom sensor can both (i) detect the type of liquid and/or measure the dielectric constant and (ii) measure the liquid level at the bottom of the tank or container.

Another embodiment relates to a probe for measuring the type of liquid and/or level of liquid within a tank or container comprising no moving parts.

Another embodiment relates to a probe for measuring the type of liquid and/or level of liquid within a tank or container comprising no active electronic components in the probe.

Another embodiment relates to a probe for measuring the type of liquid and/or level of liquid within a tank or container and being completely water tight.

The magnetic field response sensors used in the long tube range in size, but preferably range from about two to four inches wide to about ten to twenty four inches high.

The magnetic field response sensor in FIG. 1, for example, is preferably about three inches by ten inches with the small sensor inside about two inches square. However, the size can vary depending on the application.

The tube is preferably filled with silicon rubber to keep it water tight and to prevent the tube from floating. Other materials can be used, but silicon rubber was found to have the least effect on the sensor's magnetic field.

Advantageous for many applications, the sensors according to the invention can be made inexpensively and are preferably disposable.

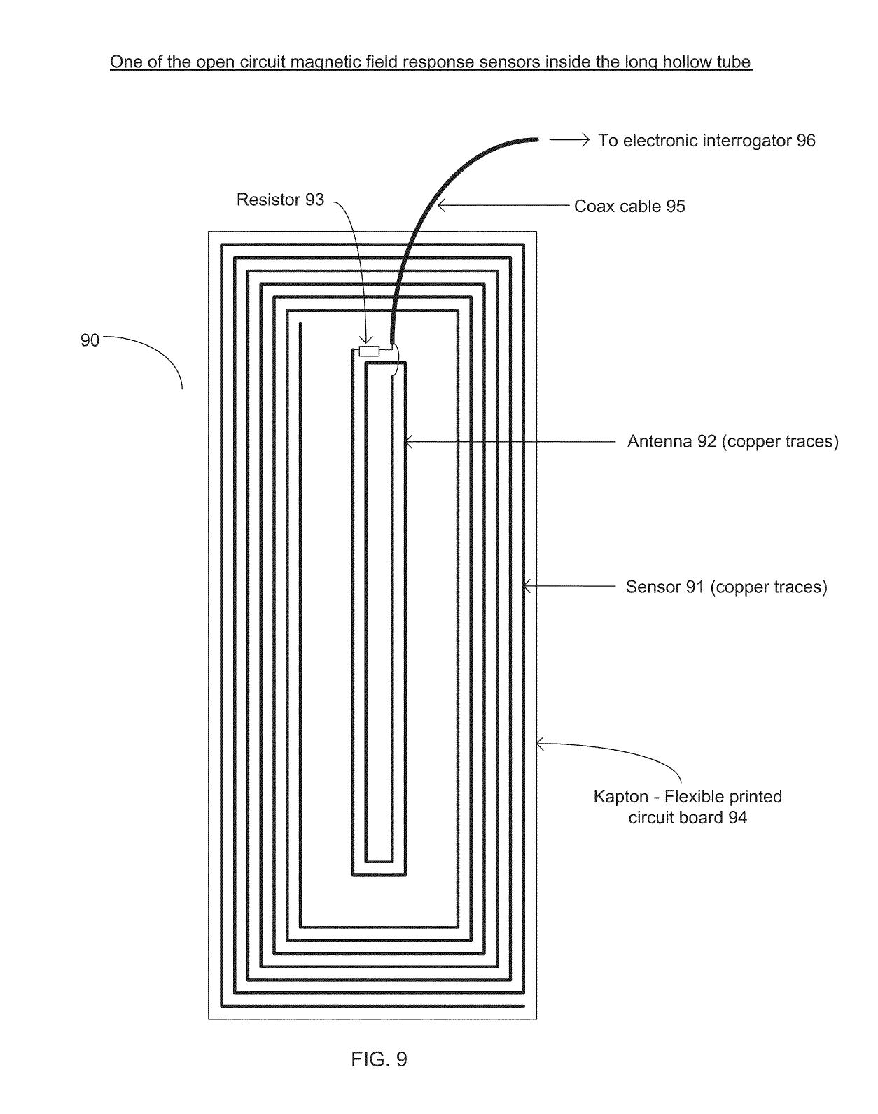

FIG. 9 shows a drawing of sensor system 90 for use in the sensor probe of FIG. 8 without a small sensor in the middle of the sensor 91 according to another embodiment of the invention. Sensor system 90 comprises antenna 92 shown inside the middle of sensor 91 illustrating the different configurations of the sensor system depending on the application. This configuration in the long tube is advantageous for use as the bottom sensor to measure the type of fluid. The small sensor inside the large sensor as shown in FIG. 5 and FIG. 6 in the short tube is not needed for such applications. Moreover, having the antenna 92 in the middle of the sensor 91 with the sensor 91 curved into the tube (not shown) provides a better signal response. Preferably, the sensor will work either way with the antenna around the outside or in the middle of the sensor. Preferably, sensor 91 is comprised of a copper trace on flexible printed circuit board 94. Resistor 93 is preferably used to match the antenna to the impedance of the coax cable 94. The sensor system 90 preferably includes coax cable 94 leads to one of the channels in electronic interrogation unit 96.

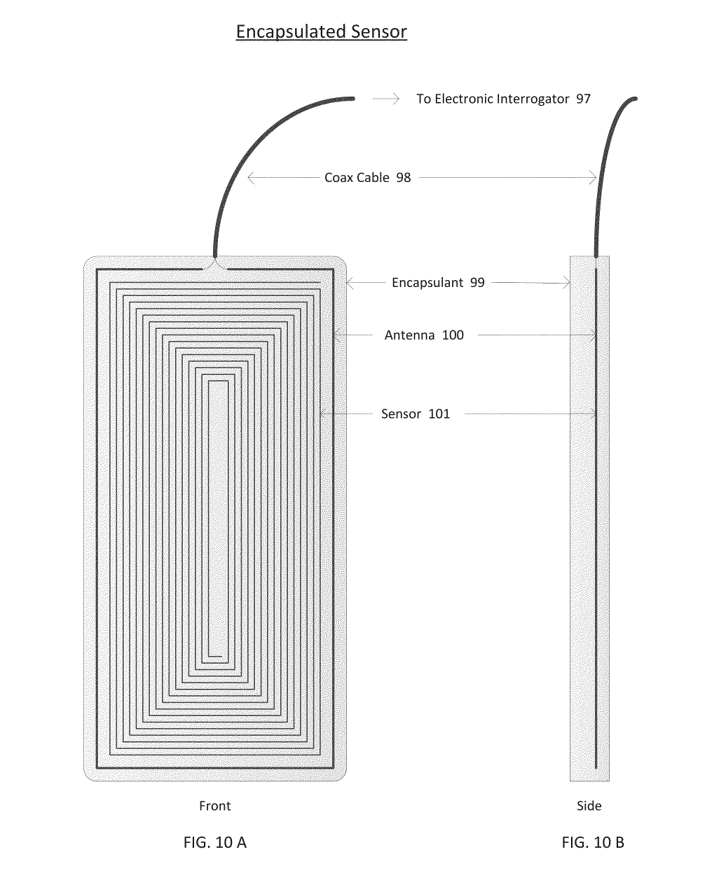

FIG. 10A shows a drawing of an open-circuit magnetic field response sensor 101 encapsulated into a flexible electrical insulated elastomer 99 formulated to adhere to a bonding agent (not shown). FIG. 10B is a side view of the encapsulated sensor. Encapsulating the sensor protects the sensor during handling and bonding to a plastic tank. This is one method that can be used in a production facility where fuel level sensors are glued to the outside wall of automobile polyethylene fuel tanks.

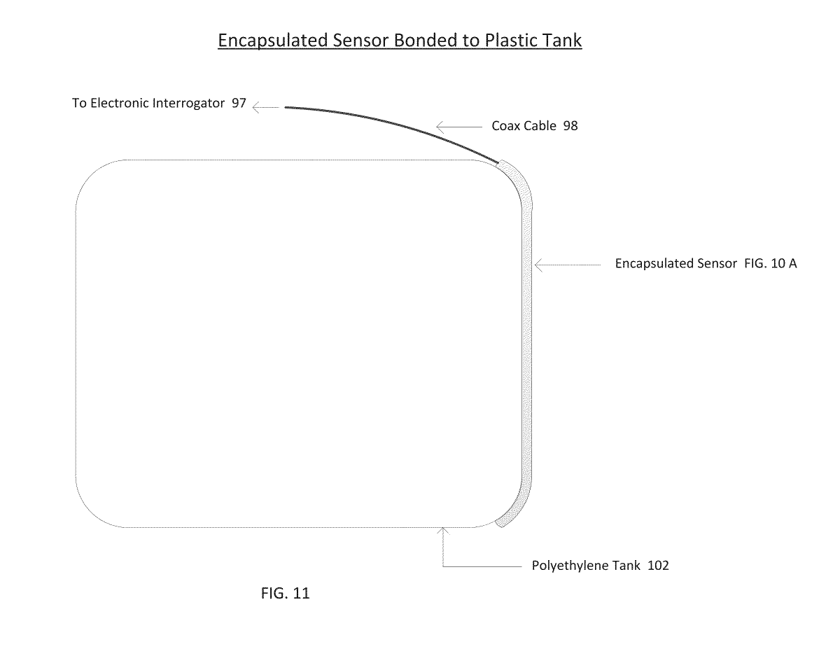

FIG. 11 shows a drawing of the sensor bonded to the outside wall of a polyethylene fuel tank 102. Most automobile fuel tanks are made of polyethylene (although the invention also includes tanks made of other materials) and have curved surfaces. The flexible elastomer encapsulate allows the sensor to fit around the curved surfaces to allow maximum sensing of the fuel in the tank. In FIG. 11, a single sensor 101 with antenna 100 both composed of copper traces on a Kapton film with a coax cable 98 connecting to the antenna 100 is encapsulated into an elastomer. The other end of the coax cable connects to an electronic interrogator 97 that converts the magnetic signal frequency to a voltage to drive an analog fuel gauge or a digital signal to drive a digital gauge or data system.

According to another preferred embodiment, the sensor probe comprises two or more different types of sensors or sensor systems.

### EXAMPLES

The present invention will be described in greater detail by reference to the following Examples, but it should be understood that the invention is not construed as being limited thereto.

### Example 1

### Sensor System for OEM Tank

A sensor system according to the invention (e.g., of FIG. 2) is secured to the tank and connected to a switched 12 volt ignition system by connecting the supplied “S”, ground and power wires to the back of the fuel gauge using separately purchased electrical connectors (recommend heat shrink terminals and connectors). Power for the control box is attached to the switched ignition wire removed from the fuel gauge while making sure to insulate the wires so they do not short out anything later. The cable is connected to the threaded connector of the control box. The boat power is turned on and the key to the battery turned to the on position generating a beep from the sensor system indicating the system is working. Preferred systems have reverse polarity protection which protects the sensor and probe from damage when the power and ground wires are connected to a power source in reverse.

### Example 2

### Calibrating a Probe Sensor

A sensor probe according to the invention is in hand. The installation and calibration is best done if tank is ½ to ¾ full rather than full. Care is taken to ensure only holding the white plastic and not the metal bars. Another person holds the “PF” or probe finder button for four seconds. This enables the control unit to send a signal to the probe, which selects the proper program for the length you have cut the sending unit probes to (see Example 1). To set the level, start with setting the empty (marked with E on control unit). Then set the full (marked with an F). To start, disregard one half inch because the sending unit probes are one half inch off the bottom. For example, if you have a 10-inch deep tank and your fuel measures 5 inches, you have a ½ tank. But you also only have 4 inches of usable fuel. You will set the “high” setting of the fuel gauge to just below ½ a tank. On metal tanks, the metal will naturally throw the reading off the amount needed to compensate for the ½ inch difference. If you are using a plastic tank, you will have to adjust the level for about ⅛ of a tank. Repeat this about 4-5 times until the needle stays were you want it in and out of the tank. Use RTV on both sides of the gasket and screw it down snug. The Viton® gasket is formulated to work with all existing fuels on the world market today.

### Example 3

### Port a Potty System with Improved Sensor Probe for Waste Tank

A sensor probe according to the invention is installed in a Port a Potty waste tank. The probe is equipped with sensors to measure the fluid level and waste level. The probe sends a signal to an indicator when either the tank is (i) too full with waste or (ii) the concentration of waste in the tank indicates servicing is required.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

With respect to the appended claims, unless stated otherwise, the term “first” does not, by itself, require that there also be a “second”. Moreover, reference to only “a first” and “a second” does not exclude additional items (e.g., sensors). While the particular sensors, sensor systems, tanks, containers and methods described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention.

1. A fluid container having a fluid sensor system comprising:
(a) a first magnetic field response sensor embedded within a wall of said fluid container; and
(b) a second magnetic field response sensor embedded within said wall of said fluid container;
wherein said first magnetic field response sensor and said second magnetic field response sensor are each capable of measuring at least one of the following: (i) fluid level within said fluid container; (ii) fluid type within said fluid container; and (iii) contaminants within said fluid container.

2. The system of claim 1, wherein said system comprises no direct electrical contact to said first magnetic field response sensor and no direct electrical contact to said second magnetic field response sensor.

3. The system of claim 1, wherein said first magnetic field response sensor and said second magnetic field response sensor are each non-mechanical open-circuit magnetic field response wireless sensors.

4. The system of claim 1, wherein said first magnetic field response sensor and said second magnetic field response sensor are each thin film open-circuit magnetic field response wireless sensors.

5. The system of claim 1, wherein said second magnetic field response sensor is smaller than the first magnetic field response sensor.

6. The system of claim 5, wherein said second magnetic field response sensor is positioned within the field of said first magnetic field response sensor.

7. The system of claim 1, wherein said first magnetic field response sensor and said second magnetic field response sensor are each a thin film open-circuit electrical conductor shaped to store electrical and magnetic energy.

8. The system of claim 1, wherein said first magnetic field response sensor is capable of measuring the fluid level and said second magnetic field response sensor is capable of detecting the fluid type.

9. The system of claim 1, wherein said second magnetic field response sensor is capable of detecting fluid type by measuring the dielectric constant of the fluid.

10. The system of claim 1, wherein said first magnetic field response sensor can be calibrated by the measurement of the second magnetic field response sensor to increase the accuracy of the fluid level measurement.

11. The system of claim 1, further comprising a magnetic antenna.

12. The system of claim 1, further comprising an external magnetic antenna proximate said first magnetic field response sensor and said second magnetic field response sensor.

13. The system of claim 11, wherein said magnetic antenna is capable of exciting the first magnetic field response sensor and said second magnetic field response sensor using a time-varying magnetic field and is also capable of receiving time-varying magnetic field signals from the first magnetic field response sensor and said second magnetic field response sensor and conveying those signals to a electronic interrogator.

14. The system of claim 13, wherein said electronic interrogator is capable of converting the signals from sensors to at least one voltage that can drive an analog or digital fluid gauge or other data acquisition system.

15. The system of claim 1, further comprising a magnetic antenna embedded within said wall of said container.

16. The system of claim 15, wherein said sensors and antenna are embedded in the same plane within the container wall.

17. The system of claim 15, further comprising a coax cable connected to said magnetic antenna and protruding through a container wall for connection to an electrical interrogator.

18. The system of claim 1, wherein said first magnetic field response sensor and said second magnetic field response sensor are embedded in the wall by positioning the sensors within a mold prior to injecting plastic to form the container.

19. The system of claim 1, wherein said fluid is a fuel.

20. The system of claim 1, wherein said container is a fuel container.

21. The system of claim 1, wherein said container is an automobile fuel container.

22. The system of claim 1, wherein said container is a polyethylene fuel container.

23. The system of claim 1, further comprising at least one antenna in proximity to first magnetic field response sensor and said second magnetic field response sensor and capable of applying excitation to the sensors.

24. The system of claim 23, wherein said excitation is applied via a time-varying magnetic field from said magnetic antenna.

25. The system of claim 1, wherein said system is non-mechanical.

26. The system of claim 1, wherein said system comprises no moving parts.

27. The system of claim 1, wherein said first magnetic field response sensor and said second magnetic field response sensor do not include a float.

28. The system of claim 1, wherein said system does not include a float.

29. The system of claim 1, wherein said first magnetic field response sensor and said second magnetic field response sensor each resonate to generate a response having frequency, amplitude and bandwidth.

30. A fluid sensor system for a fluid container comprising:
(a) a first magnetic field response sensor secured to an outside wall of said fluid container; and
(c) a second magnetic field response sensor secured to said outside wall of said fluid container;
wherein said first magnetic field response sensor and said second magnetic field response sensor each measure at least one of the following: (i) fluid level within said fluid container; (ii) fluid type within said fluid container; and (iii) contaminants within said fluid container.

31. The system of claim 30, wherein said container is a non-conductive container.

32. The system of claim 30, wherein said system does not employ a float to measure the fluid.

33. The system of claim 30, further comprising a magnetic antenna.

34. The system of claim 30, further comprising an external magnetic antenna proximate said first magnetic field response sensor and said second magnetic field response sensor.

35. The system of claim 30, further comprising a magnetic antenna embedded within said wall of said fluid container.

36. The system of claim 30, further comprising a magnetic antenna secured to said outside wall of said fluid container.

37. The system of claim 36, wherein said sensors and antenna are secured on the same plane of said fluid container wall.

38. A method of measuring fluid within a fluid container, said method comprising:
(a) exciting a first magnetic field response sensor and a second magnetic field response sensor with a magnetic antenna using a time-varying magnetic field;
(b) receiving time-varying magnetic field signals from the first magnetic field response sensor and said second magnetic field response sensor; and
(c) conveying those signals to an electronic interrogator.

39. The method of claim 38, wherein said first magnetic field response sensor and said second magnetic field response sensor measure at least one of the following: (i) fluid level within said fluid container; (ii) fluid type within said fluid container; and (iii) contaminants within said fluid container.

40. The method of claim 38, wherein said first magnetic field response sensor measures the fluid level and said second magnetic field response sensor detects the fluid type.

41. The method of claim 38, wherein said first magnetic field response sensor and said second magnetic field response sensor each resonate to generate a response having a frequency, amplitude and bandwidth.

42. The method of claim 38, wherein said first magnetic field response sensor measures the fluid level and said second magnetic field response sensor detects the fluid type.

43. The method of claim 42, wherein said second magnetic field response sensor detects the fluid type by measuring the dielectric constant of the fluid.

44. The method of claim 42, wherein said first magnetic field response sensor is calibrated by the measurement of the second magnetic field response sensor to increase the accuracy of the fluid level measurement.

45. The method of claim 38, further comprising said electronic interrogator converting the signals from sensors to at least one voltage that can drive an analog or digital fluid gauge or other data acquisition system.

46. A fluid sensor probe comprising:
(a) a first magnetic field response sensor and a second magnetic field sensor, each sensor secured on an inner surface of a non-conductive hollow tube;
(b) an internal magnetic antenna also secured on said inner surface of the hollow tube; and
(c) a magnetic coupling coil connected to said internal magnetic antenna.
wherein:
both ends of said hollow tube are sealed;
said system comprises no direct electrical contact to said first magnetic field response sensor and no direct electrical contact to said second magnetic field response sensor; and
said first magnetic field response sensor and said second magnetic field response sensor each measure at least one of the following: (i) fluid level within said fluid container; (ii) fluid type within said fluid container; and (iii) contaminants within said fluid container.

47. The probe of claim 46, further comprising an external magnetic antenna proximate one end of said hollow tube.

48. The probe of claim 47, further comprising a cable capable of connecting said external magnetic antenna to an electronic interrogator.

49. The probe of claim 46, wherein said non-conductive hollow tube is filled with a silicon rubber compound.

50. A fluid sensor probe comprising:
(a) a first magnetic field response sensor and a second magnetic field sensor, each sensor embedded within a wall of a non-conductive hollow tube;
(b) an internal magnetic antenna also embedded with said wall of the hollow tube; and
(c) a magnetic coupling coil connected to said internal magnetic antenna.
wherein:
both ends of said hollow tube are sealed;
said system comprises no direct electrical contact to said first magnetic field response sensor and no direct electrical contact to said second magnetic field response sensor; and
said first magnetic field response sensor and said second magnetic field response sensor each measure at least one of the following: (i) fluid level within said fluid container; (ii) fluid type within said fluid container; and (iii) contaminants within said fluid container.

51. A fluid sensor probe comprising:
(a) a first magnetic field response sensor and a second magnetic field sensor, each secured on an inner surface of a non-conductive hollow tube;
(b) an internal magnetic antenna within the hollow tube;
(c) a magnetic coupling coil connected to said internal magnetic antenna;
(d) an external magnetic antenna proximate one end of said hollow tube; and
(e) a cable capable of connecting said external magnetic antenna to an electronic interrogator;
wherein:
both ends of said hollow tube are sealed;
said system comprises no direct electrical contact to said first magnetic field response sensor or said second magnetic field response sensor; and
said first magnetic field response sensor and said second magnetic field response sensor each measure at least one of the following: (i) fluid level within said fluid container; (ii) fluid type within said fluid container; (iii) contaminants within said fluid container.

52. The probe of claim 51, wherein said non-conductive hollow tube is filled with a silicon rubber compound.

53. A fluid sensor probe comprising:
(a) a first magnetic field response sensor and a second magnetic field sensor, each secured on an inner surface of a non-conductive hollow tube;
(b) an internal magnetic antenna within the hollow tube; and
(c) a cable capable of connecting said internal magnetic antenna to an electronic interrogator by protruding from one end or a wall of said hollow tube;
wherein:
both ends of said hollow tube are sealed;
said system comprises no direct electrical contact to said first magnetic field response sensor or said second magnetic field response sensor; and
said first magnetic field response sensor and said second magnetic field response sensor each measure at least one of the following: (i) fluid level within said fluid container; (ii) fluid type within said fluid container; (iii) contaminants within said fluid container.

54. The probe of claim 53, wherein said non-conductive hollow tube is filled with a silicon rubber compound.

55. The system of claim 1, wherein said first magnetic field response sensor and said second magnetic field response sensor are capable of working together when obtaining one or more measurements.

56. The system of claim 1, further comprising an electronic interrogator programmed with software that interrogates both sensors and combines the information to read the level of any liquid.

57. The system of claim 1, further comprising an electronic interrogator capable of reading each sensor and combining results to measure said fluid

58. A fluid container comprising at least two sensor systems according to claim 1, each sensor system located at different container positions.

59. A fluid container comprising a measuring system including at least two sensor systems according to claim 1, each sensor system located at different container positions and said measuring system capable of combining measurements from said at least two sensor systems to generate a measurement of fluid within said fluid container at different pitch, yaw and/or roll attitudes.

60. The fluid container of claim 59, comprising a first sensor system positioned on a first wall of said fluid container and a second sensor system positioned on a second wall of said fluid container.

61. The fluid container of claim 60, further comprising a third sensor system positioned on a third wall of said fluid container.

62. The fluid container of claim 61, further comprising a fourth sensor system positioned on a fourth wall of said fluid container.

63. The fluid container of claim 59, wherein a measurement reading obtained from each sensor is combined in an electronic interrogator to produce a volume reading of the fluid in the container tank at different pitch, yaw and/or roll attitudes.

64. A fluid sensor probe comprising at least a first magnetic field response sensor and a second magnetic field sensor, each sensor positioned along the length of a non-conductive hollow tube.

65. The probe of claim 64, comprising at least three sensors along the length of said non-conductive hollow tube.

66. The probe of claim 64, comprising at least five sensors along the length of said non-conductive hollow tube.

67. The probe of claim 64, comprising at least ten sensors along the length of said non-conductive hollow tube.

68. The probe of claim 64, wherein said sensors are along an inner surface of said non-conductive hollow tube.

69. The probe of claim 64, further comprises a magnetic antenna for each sensor.

70. The probe of claim 64, comprising one antenna for two or more sensors.

71. The probe of claim 64, further comprises an internal magnetic antenna for each sensor.

72. The probe of claim 71, further comprising one or more internal embedded coax cables connecting each sensor's internal magnetic antenna to one or more corresponding external coax cables.

73. The probe of claim 64, wherein said non-conductive hollow tube is filled with a silicon rubber compound.

74. The probe of claim 64, comprising multiple sensors along the entire length of the hollow tube.

75. The probe of claim 64, wherein said sensors are along the outer surface of said non-conductive hollow tube.
